(19) United States
(12) Patent Application Publication
(10) Pub. No.: US 2003/0173505 A1
(43) Pub. Date: Sep. 18, 2003

(54) Multiple phase wavelength locker

(75) Inventor: Torsten Wipiejewski, Kowloon (HK)

Correspondence Address: GATES & COOPER LLP, HOWARD HUGHES CENTER, 6701 CENTER DRIVE WEST, SUITE 1050, LOS ANGELES, CA, 90045, US

(73) Assignee: AGILITY COMMUNICATIONS, INC.

(21) Appl. No.: 10/389,123

(22) Filed: Mar. 14, 2003

Related U.S. Application Data
(60) Provisional application No. 60/364,246, filed on Mar. 14, 2002.

(51) Int. Cl. G01J 3/50

(52) U.S. Cl. 250/226

(57) ABSTRACT

A multiple phase wavelength locker employs an etalon with multiple steps, the steps providing optical cavities having different optical lengths for use with multiple photodetectors, such that a resonance position of each etalon step is offset by a fraction of a resonance period. The stepped etalon can be employed to track the exact wavelength of a laser in a wavelength division multiplexing (WDM) system.

### CROSS-REFERENCE TO RELATED APPLICATIONS

This application claims the benefit under 35 U.S.C. §119(e) of co-pending and commonly-assigned U.S. provisional patent application Serial No. 60/364,246, filed Mar. 14, 2002, by Torsten Wipiejewski, and entitled “THREE PHASE WAVELENGTH LOCKER,” which application is incorporated by reference herein.

### BACKGROUND OF THE INVENTION

1. Field of the Invention

This invention relates to wavelength lockers for lasers, and more particularly, to a multiple phase wavelength locker.

2. Description of the Related Art

For widely tunable lasers, wavelength lockers usually employ one etalon and two photodetectors. FIG. 1 illustrates the structure of an optoelectronic device 100 having a laser 102, lens 104, isolator 106 and a wavelength locker including two taps 108, 110, an etalon 112, two photodetectors 114, 116, an output beam 118 and a thermoelectric cooler (TEC) 120. The etalon 112 and associated photodetector 116 are used to track the wavelength of the output beam 118 and provide feedback to a control circuit (not shown). The other photodetector 114 provides a reference signal.

The wavelength of the output beam 118 is controlled in such a way that it is aligned with a frequency channel of the ITU (International Telecommunication Union) grid. The frequency spacing of the etalon 112 needs to be the same as the ITU grid. For most applications this is 50 GHz.

Thus, the etalon 112 thickness has to be made with extremely high precision to achieve the desired wavelength (optical frequency) spacing. At the wavelength of interest, around 1550 nm, the correlation between optical frequency spacing and wavelength difference is Δf(GHz)=Δλ(pm)/8. The necessary precision makes the etalon 112 expensive.

The etalon 112 resonance wavelength also needs to be aligned to the channels of the ITU grid with an offset. This requires a high precision mounting step or a way of tuning the etalon 112 after the mounting procedure. In either case, the cost of the device 100 is increased.

U.S. Pat. No. 6,323,987 to Rinaudo et al. describes a different approach of a stepped etalon with the transmission through the etalon being offset by the different length of the etalon in the various positions. In Rinaudo, the transmission through the etalon depends on the position at the device. Each position exhibits almost identical transmission versus wavelength curves, but according to the different position on the etalon, the transmission curves show a phase offset. The wavelength can be determined by comparing the transmission intensity for the three etalon positions.

### SUMMARY OF THE INVENTION

The present invention discloses a monolithically integrated wavelength detection device employing a plurality of photodetectors and an etalon with a plurality of steps, the steps providing optical cavities having different optical lengths for use with the photodetectors, wherein a resonance wavelength of each cavity is spectrally offset from adjacent cavities, resulting in a spectral response of a signal from each of the photodetectors with a phase difference according to a fraction of the wavelength resonance period, and resulting in a detectable slope of a spectral response for all wavelengths. A thickness difference between adjacent steps corresponds to a wavelength offset of different resonance peaks. A sum of signals resulting from the steps of the etalon comprises a reference signal. A wavelength change can be detected independent of an absolute wavelength position of the etalon.

### BRIEF DESCRIPTION OF THE DRAWINGS

Referring now to the drawings in which like reference numbers represent corresponding parts throughout:

FIG. 1 illustrates the structure of an optoelectronic device;

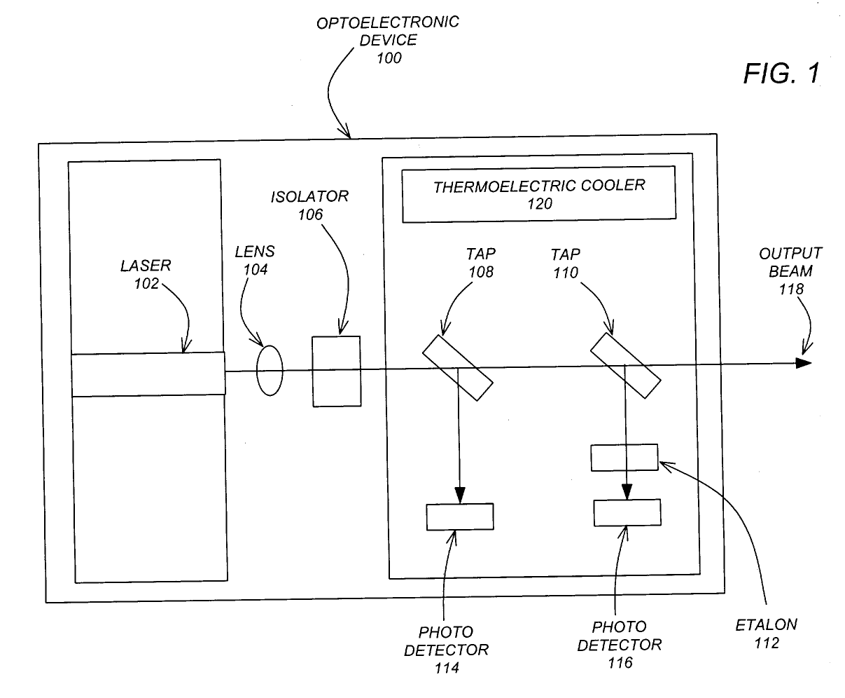

FIG. 2 illustrates the structure of an optoelectronic device according to an embodiment of the invention;

FIG. 3 is a graph illustrating the absorption and the corresponding relative photocurrent response in a multiple phase wavelength locker according to the preferred embodiment of the invention; and

FIG. 4 illustrates the structure of an optoelectronic device according to another embodiment of the invention.

### DETAILED DESCRIPTION OF THE PREFERRED EMBODIMENTS

In the following description, reference is made to the accompanying drawings which form a part hereof, and in which is shown, by way of illustration, a preferred embodiment of the present invention. It is understood that other embodiments may be utilized and structural changes may be made without departing from the scope of the present invention.

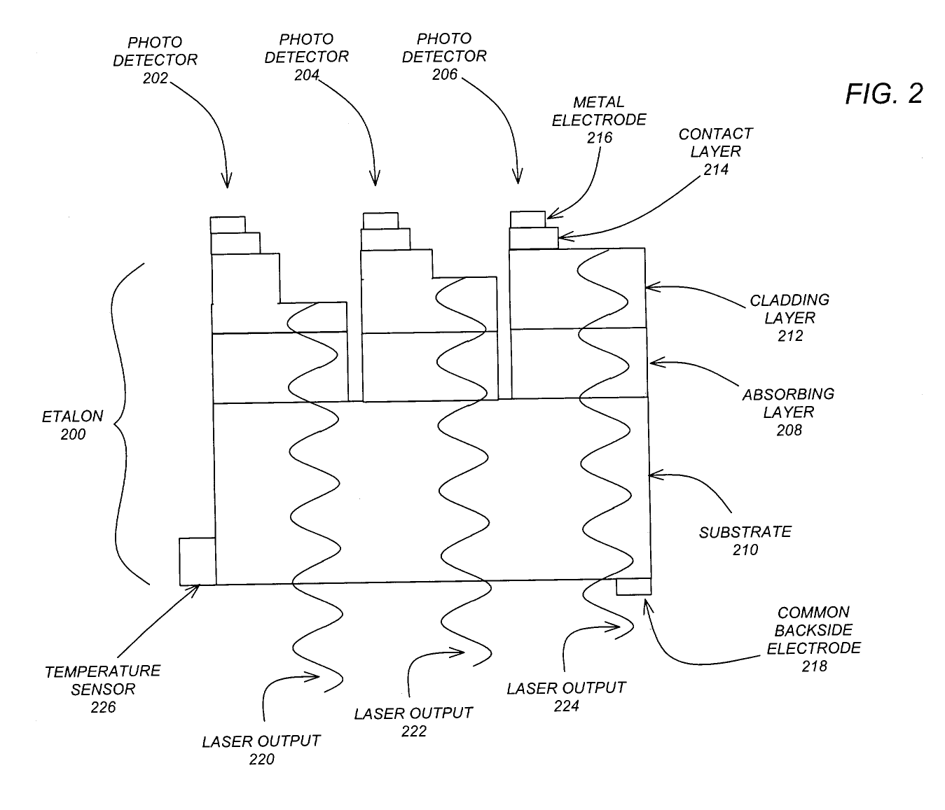

FIG. 2 illustrates the structure of an optoelectronic device according to the present invention, comprising an etalon 200 with three monolithically integrated pin-photodiodes 202, 204, 206. The pin-photodiodes 202, 204, 206 incorporate an i-InGaAs absorbing layer 208 fabricated on top of an n-InP substrate 210 and sandwiched by a p-InP cladding layer 212. The pin-photodiodes 202, 204, 206 may include another heavily p-type doped contact layer 214 on their top surface. An electrical connection is made by a metal electrode 216 on top of the contact layer 214 and a common backside electrode 218 on the substrate 210.

Laser output 220, 222, 226 reach the pin-photodiodes 202, 204, 206 through the substrate 210, wherein the substrate 210 forms, together with the top surface of the pin-photodiodes 202, 204, 206, the etalon 200. The laser output 220, 222, 226 is absorbed in the undoped absorption layer 208 of the pin-photodiodes 202, 204, 206. The amount of absorption is wavelength dependent according to the etalon 200 resonance. The etalon 200 thickness is identical for every integrated pin-photodiode 202, 204, 206, except for a small thickness difference created by etching of the topmost cladding layer 212.

The thickness differences in the topmost cladding layer 212 provide three steps in the etalon 200 for use with the plurality of pin-photodiodes 202, 204, 206. The three steps provide optical cavities having different optical lengths for use with the three pin-photodiodes 202, 204, 206, wherein a resonance wavelength of each cavity is spectrally offset from adjacent cavities, resulting in a spectral response of a signal from each of the pin-photodiode 202, 204, 206 with a phase difference according to a fraction of the wavelength resonance period, and resulting in a detectable slope of a spectral response for all wavelengths. A thickness difference between adjacent steps corresponds to a wavelength offset of different resonance peaks. A sum of signals resulting from the steps of the etalon 200 comprises a reference signal. A wavelength change can be detected independent of an absolute wavelength position of the etalon 200.

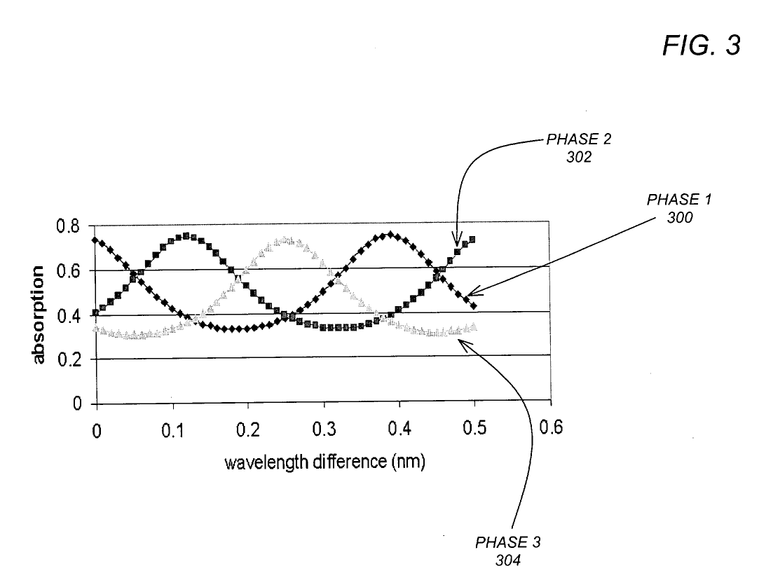

FIG. 3 is a graph illustrating the absorption and the corresponding relative photocurrent response in the structure of FIG. 2. The absorption is proportional to the photocurrent signals detected by each of the photodiodes 202, 204, 206, and is represented by phases 300, 302, 304, respectively. The photocurrent signals exhibit strong resonances for certain wavelengths in a periodic way. Due to the small etalon 200 thickness difference at the steps, the position of the photocurrent signals' maxima is different for the three photodiodes 202, 204, 206, as represented by the phases 300, 302, 304. The difference of the photocurrent signals can be used to precisely determine the wavelength of the incoming light.

The photocurrent response in FIG. 3 is calculated for the case that the reflectivity of the substrate 210 back side is 10% and the top of the cladding layer 212 is 90%. Both surfaces 210 and 212 may contain additional coating layers to create the desired reflectivity values. The coating on the substrate 208 back side acts as a partial anti-reflection (AR) coating, while the coating on the top of the cladding surface 212 is a highly reflective coating. The coating on the top of the cladding surface 212 could also be a metal coating to achieve the high reflectivity, wherein no light passes through the device in the case of a metal coating.

The absorbing layer 208 is 200 nm thick, with an absorption coefficient of 10,000 cm⁻¹. The thickness of the absorbing layer 208 could be changed to optimize the photocurrent response without changing the principle of the multiple phase wavelength locker.

The highest photocurrent can be obtained when the total absorption is adjusted such that the reflectivity of the back side of the substrate 210 decreased by the amount of total absorption in the etalon 200 equals the reflectivity of the top of the cladding layer 212. In this particular case, the thickness of the absorption layer 212 would be 550 nm. However, for the application as wavelength detection device, the photocurrent response might be adjusted according to other parameters, such as the wavelength dependence of the photocurrent signal.

The thickness adjustment of the etalon 200 can be performed more easily on the top of the cladding layer 212 rather than the back side of the substrate 210. Wet or dry etching techniques may be employed. Anodic oxidation followed by selective wet etching has been demonstrated earlier to be an adequate technique. See, for example, the publication by T. Wipiejewski et al., entitled “Multiple Wavelength Vertical Cavity Surface Emitting Laser Diode Arrays,” IEEE Photon. Tech. Lett., 1996, which publication is incorporated by reference herein.

The thickness of the etalon 200 needs to be adjusted according to the different refractive index of the p-InP substrate 210 as compared to glass. In this embodiment, the etalon 200 has a total thickness, through the p-InP cladding layer 212, of approximately 946 μm for a channel spacing of 50 GHz, while the thickness difference between adjacent steps is 81 nm, which corresponds to a one third or 120° wavelength offset of the different resonance peaks.

A temperature sensor 226 can also be monolithically integrated in the substrate 210. The temperature sensor 226 could be, for example, a simple pn-junction where there is a voltage change with temperature at a constant current. The signal from the temperature sensor 226 can be used to extend the accuracy of the wavelength locker over a wider temperature range.

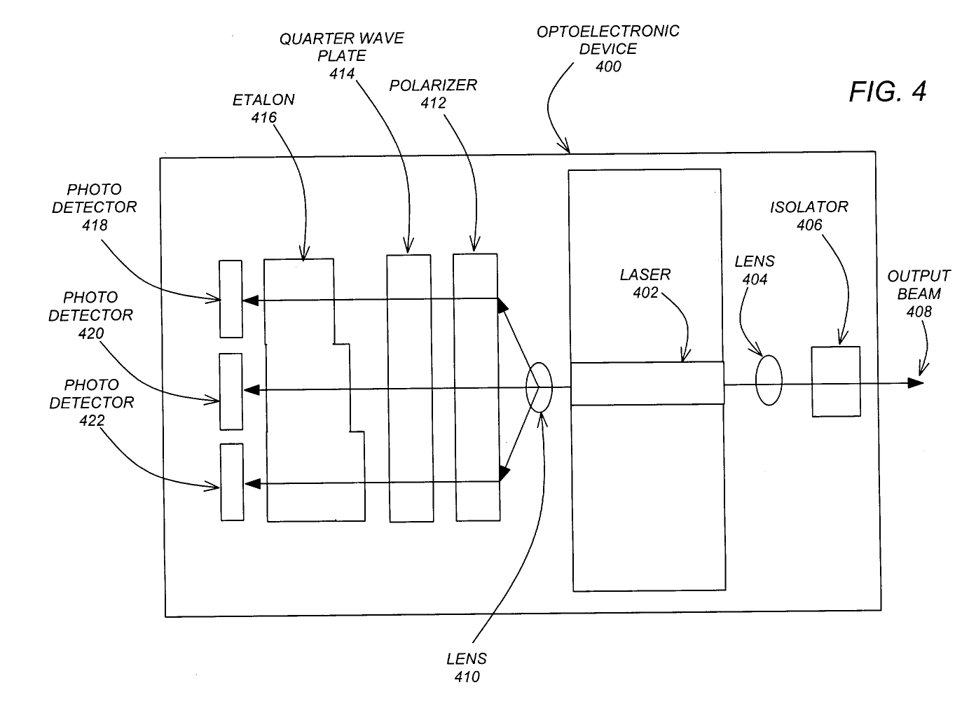

FIG. 4 illustrates the structure of an optoelectronic device 400 according to an another embodiment of the present invention, including a laser 402, lens 404, isolator 406, output beam 408, and a wavelength detection device, namely a multiple phase wavelength locker, comprised of lens 410, polarizer 412, quarter-wave plate 414, etalon 416 and photodetectors 418, 420, 422.

The additional lens 410 focuses the light and distributes it across three paths in the wavelength locker device. The polarizer 412 and quarter-wave plate 414 are employed to reduce back reflections of these signals. For every wavelength, there is a variation in at least two of the signals, as described in FIG. 3. Thus, a wavelength change can be detected independent of the absolute wavelength position of the etalon 416. Therefore, the total thickness of the etalon 416 is not critical. Also, no alignment to the ITU grid is necessary.

The plurality of steps in the etalon 416 provide optical cavities having different optical lengths for use with the photodetectors 418, 420, 422, wherein a resonance wavelength of each cavity is spectrally offset from adjacent cavities, resulting in a spectral response of a signal from each of the photodetectors 418, 420, 422 with a phase difference according to a fraction of the wavelength resonance period, and resulting in a detectable slope of a spectral response for all wavelengths. A thickness difference between adjacent steps corresponds to a wavelength offset of different resonance peaks. A sum of signals resulting from the steps of the etalon 416 comprises a reference signal. A wavelength change can be detected independent of an absolute wavelength position of the etalon 416.

Since the wavelength locker signal is basically independent of the wavelength, the locking range can also be extended. For example, instead of setting the locking range corresponding to the ITU channel spacing, it can also be set to a spacing of three channels (150 GHz). The wavelength locker can then detect the wavelength, even if the output beam 408 of the laser 402 is closer to a neighboring channel. This approach might relax the reliability requirements for tunable lasers 402.

Moreover, the wavelength locker is configured for back facet monitoring of the laser 402, although front facet monitoring may be employed as well. For front facet monitoring, the polarizer 412 and the quarter-wave plate 414 may not be necessary.

### Conclusion

This concludes the description of the preferred embodiment of the invention. The following describes some alternative embodiments for accomplishing the present invention.

For example, different configurations and different numbers of etalons, steps and photodetectors other than those explicitly described herein could be used without departing from the scope of the present invention. In addition, different materials and different constructions or fabrications of the etalon and photodetectors other than those explicitly described herein could be used without departing from the scope of the present invention.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A monolithically integrated wavelength detection device employing a plurality of photodetectors and an etalon with a plurality of steps, the steps providing optical cavities having different optical lengths for use with the photodetectors, wherein a resonance wavelength of each cavity is spectrally offset from adjacent cavities, resulting in a spectral response of a signal from each of the photodetectors with a phase difference according to a fraction of the wavelength resonance period, and resulting in a detectable slope of a spectral response for all wavelengths.

2. The device of claim 1, wherein the plurality of photodetectors comprises three photodetectors.

3. The device of claim 1, wherein the plurality of steps comprises three steps.

4. The device of claim 1, wherein the photodetectors are photodiodes.

5. The device of claim 1, wherein a thickness difference between adjacent steps corresponds to a wavelength offset of different resonance peaks.

6. The device of claim 1, wherein a sum of signals resulting from the steps of the etalon comprises a reference signal.

7. The device of claim 1, wherein a wavelength change can be detected independent of an absolute wavelength position of the etalon.

8. The device of claim 1, wherein the photodetectors are constructed on top of a common n-InP substrate.

9. The device of claim 1, wherein the photodetectors include an i-InGaAs absorbing layer, p-InP cladding layer, p-InGaAs contact layer and p-contact metal.

10. The device of claim 9, wherein the common n-InP substrate includes a common back side electrode.

11. The device of claim 9, wherein a temperature sensor element is integrated with the InP substrate

12. The device of claim 1, further comprising a polarizer and a quarter-wave plate for reducing back reflections from the wavelength locker device.

13. The device of claim 1, further comprising a tunable laser for generating the optical signal.

14. A method of monitoring a wavelength of an output beam from a laser using a wavelength detection device, comprising:
transmitting the beam through a monolithically integrated wavelength detection device employing a plurality of photodetectors and an etalon with a plurality of steps, the steps providing optical cavities having different optical lengths for use with the photodetectors, wherein a resonance wavelength of each cavity is spectrally offset from adjacent cavities, resulting in a spectral response of a signal from each of the photodetectors with a phase difference according to a fraction of the wavelength resonance period, and resulting in a detectable slope of a spectral response for all wavelengths.

15. The method of claim 14, wherein the plurality of photodetectors comprises three photodetectors.

16. The method of claim 14, wherein the plurality of steps comprises three steps.

17. The method of claim 14, wherein the photodetectors are photodiodes.

18. The method of claim 14, wherein a thickness difference between adjacent steps corresponds to a wavelength offset of different resonance peaks.

19. The method of claim 14, wherein a sum of signals resulting from the steps of the etalon comprises a reference signal.

20. The method of claim 14, wherein a wavelength change can be detected independent of an absolute wavelength position of the etalon.

21. The method of claim 14, wherein the photodetectors are constructed on top of a common n-InP substrate.

22. The method of claim 14, wherein the photodetectors include an i-InGaAs absorbing layer, p-InP cladding layer, p-InGaAs contact layer and p-contact metal.

23. The method of claim 22, wherein the common n-InP substrate includes a common back side electrode.

24. The method of claim 22, wherein a temperature sensor element is integrated with the InP substrate

25. The method of claim 14, further comprising reducing back reflections from the wavelength locker device using a polarizer and a quarter-wave plate.

26. The method of claim 14, further comprising generating the optical signal using a tunable laser.

27. An optoelectronic device, comprising:
a laser for generating an output beam; and
a monolithically integrated wavelength detection device, coupled to the laser, employing a plurality of photodetectors for detecting the output beam and an etalon with a plurality of steps, the steps providing optical cavities having different optical lengths for use with the photodetectors, wherein a resonance wavelength of each cavity is spectrally offset from adjacent cavities, resulting in a spectral response of a signal from each of the photodetectors with a phase difference according to a fraction of the wavelength resonance period, and resulting in a detectable slope of a spectral response for all wavelengths.

28. The device of claim 27, wherein the plurality of photodetectors comprises three photodetectors.

29. The device of claim 27, wherein the plurality of steps comprises three steps.

30. The device of claim 27, wherein the photodetectors are photodiodes.

31. The device of claim 27, wherein a thickness difference between adjacent steps corresponds to a wavelength offset of different resonance peaks.

32. The device of claim 27, wherein a sum of signals resulting from the steps of the etalon comprises a reference signal.

33. The device of claim 27, wherein a wavelength change can be detected independent of an absolute wavelength position of the etalon.

34. The device of claim 27, wherein the photodetectors are constructed on top of a common n-InP substrate.

35. The device of claim 27, wherein the photodetectors include an i-InGaAs absorbing layer, p-InP cladding layer, p-InGaAs contact layer and p-contact metal.

36. The device of claim 35, wherein the common n-InP substrate includes a common back side electrode.

37. The device of claim 35, wherein a temperature sensor element is integrated with the InP substrate

38. The device of claim 27, further comprising a polarizer and a quarter-wave plate for reducing back reflections from the wavelength locker device.
